(19) United States
(12) Patent Application Publication
(10) Pub. No.: US 2012/0176022 A1
(43) Pub. Date: Jul. 12, 2012

(54) SPARK PLUG

(75) Inventors: Keita Nakagawa, Nagoya-shi (JP); Hirokazu Kurono, Nagoya-shi (JP)

(73) Assignee: NGK SPARK PLUG CO., LTD., Nagoya-shi, Aichi (JP)

(21) Appl. No.: 13/497,816

(22) PCT Filed: Jun. 23, 2010
(86) PCT No.: PCT/JP2010/004163

§ 371 Date: Mar. 23, 2012

(30) Foreign Application Priority Data
Sep. 25, 2009 (JP) 2009-221067

(51) Int. Cl. H01T 13/38

(52) U.S. Cl. 313/141

(57) ABSTRACT

To provide a spark plug excellent in the acid resistance and high-temperature withstand voltage characteristics. A spark plug 100 including an insulator 2 being formed in an approximately cylindrical shape and having a through hole 6 penetrating in the axis direction, and a center electrode 3 inserted into the through hole 6, wherein the insulator 2 is formed by an alumina-based sintered body containing an Si component, a Ba component, a Ca component and an Mg component to satisfy the following conditions (1) and (2) and containing substantially no B component: Condition (1): the ratio R_{Ca} of the mass in terms of oxide of the Ca component to the mass in terms of oxide of the Si component is from 0.05 to 0.40; Condition (2): the ratio R_{Mg} of the mass in terms of oxide of the Mg component to the total mass of the mass in terms of oxide of the Si component, the mass in terms of oxide of the Ca component and the mass in terms of oxide of the Mg component is from 0.01 to 0.08.

### TECHNICAL FIELD

This invention relates to a spark plug. More specifically, this invention relates to a spark plug excellent in the acid resistance and high-temperature withstand voltage characteristics.

### BACKGROUND ART

The spark plug used in an internal combustion engine of an automotive engine or the like includes a spark plug insulator (sometimes referred to as an “insulator”) formed by, for example, an alumina-based sintered body using alumina (Al₂O₃) as the main component. The reason why the insulator is formed by an alumina-based sintered body is because the alumina-based sintered body is excellent in the heat resistance, mechanical strength and the like. For obtaining an alumina-based sintered body, for example, a three-component sintering aid composed of silicon oxide (SiO₂), calcium monoxide (CaO) and magnesium monoxide (MgO) is generally used for the purpose of lowering the firing temperature and enhancing the sinterability.

The combustion chamber of the internal combustion engine where such a spark plug is mounted may reach a temperature of about 700° C. and therefore, the spark plug is required to exert excellent withstand voltage characteristics in the temperature range from room temperature to about 700° C. An alumina-based sintered body suitably used for the insulator or the like of the spark plug exerting such withstand voltage characteristics has been proposed. For example, Patent Document 1 describes “an alumina-based sintered body where the air hole exposed on an arbitrary mirror-polished surface of the sintered body has the following characteristics: (a) assuming that the area ratio of the mirror-polished surface is 100%, the area ratio of the air hole is 4% or less; (b) the maximum long diameter Dmax of the air hole is 15 μm or less; and (c) when each long diameter (unit: μm) of the air hole is taken as the random variable, the standard deviation a of the area distribution represented by a lognormal distribution is 2 μm or less”.

Meanwhile, for example, when the internal combustion engine is high-powered, the temperature in the combustion chamber sometimes reaches a temperature higher than ever, for example, 800° C. or more. Therefore, the spark plug mounted on such an internal combustion engine is required to have withstand voltage characteristics at a higher temperature than ever (sometimes referred to as “high-temperature withstand voltage characteristics”).

On the other hand, in recent years, for the protection or the like of global environment, for example, a biofuel such as ethanol and a mixed fuel of fossil fuel and biofuel are attracting attention as a fuel for internal combustion engine, other than the fossil fuel such as gasoline. When such a biofuel or a mixed fuel is burned, an acid atmosphere is formed in the combustion chamber and the spark plug is exposed to an acid at a high temperature.

Most of the conventional spark plug is not assumed to be exposed to an acid atmosphere in a combustion chamber. Therefore, the spark plug, particularly, the insulator, lacks sufficient resistance to the acid atmosphere, and the conventional spark plug may not adequately function as a spark plug when mounted on an internal combustion engine using a biofuel or a mixed fuel as the fuel.

### RELATED ART

### Patent Document

Patent Document 1: JP-A-2000-247729 (the term “JP-A” as used herein means an “unexamined published Japanese patent application”)

### SUMMARY OF THE INVENTION

### Problems that the Invention is to Solve

An object of this invention is to provide a spark plug excellent in the resistance to an acid atmosphere (hereinafter, sometimes referred to as “acid resistance”) and high-temperature withstand voltage characteristics.

### Means for Solving the Problems

This invention as the means to attain the object above is a spark plug comprising an insulator being formed in an approximately cylindrical shape and having a through hole penetrating in the axis direction, and a center electrode inserted into the through hole, wherein the insulator is formed by an alumina-based sintered body containing an Si component, a Ba component, a Ca component and an Mg component to satisfy the following conditions (1) and (2) and containing substantially no B component: Condition (1): the ratio R_{Ca} of the mass (in terms of oxide) of the Ca component to the mass (in terms of oxide) of the Si component is from 0.05 to 0.40; Condition (2): the ratio R_{Mg} of the mass (in terms of oxide) of the Mg component to the total mass of the mass (in terms of oxide) of the Si component, the mass (in terms of oxide) of the Ca component and the mass (in terms of oxide) of the Mg component is from 0.01 to 0.08.

### Advantage of the Invention

In the spark plug of this invention, the insulator is formed by an alumina-based sintered body containing an Si component, a Ba component, a Ca component and an Mg component to satisfy the conditions (1) and (2) and containing substantially no B component, so that the insulator can be excellent in the withstand voltage characteristics even at a higher temperature than ever and kept from significant deterioration of its function even when exposed to an acid atmosphere. Therefore, according to this invention, a spark plug excellent in the acid resistance and high-temperature withstand voltage characteristics can be provided.

### BRIEF DESCRIPTION OF THE DRAWINGS

FIG. 1 is a partial longitudinal cross-sectional view showing the spark plug that is one example of the spark plug according to this invention.

FIG. 2 is a partial enlarged longitudinal cross-sectional view showing, in an enlarged form, the main portion on the front end side of the spark plug that is one example of the spark plug according to this invention.

FIG. 3 is a graph showing the relationship between the “rate (%) of change in the mass of Ca component and Si component between before and after dipping in concentrated hydrochloric acid for 10 minutes at ordinary temperature” and the “rate (%) of change in the strength between before and after dipping in concentrated hydrochloric acid for 10 minutes at ordinary temperature”.

FIG. 4 is an explanatory view to explain one example of the apparatus for measuring the high-temperature withstand voltage characteristics.

### MODE FOR CARRYING OUT THE INVENTION

The spark plug according to this invention includes an insulator being formed in an approximately cylindrical shape and having a through hole penetrating in the axis direction, and a center electrode inserted into the through hole. As long as the spark plug has such a configuration, the spark plug according to this invention is not particularly limited in other configurations and various known configurations may be employed. For example, the spark plug according to this invention may include the insulator, the center electrode, a metal shell formed in an approximately cylindrical shape to hold the internally inserted insulator, and a ground electrode with one end portion facing the center electrode to form a spark discharge gap between the one end portion and the center electrode.

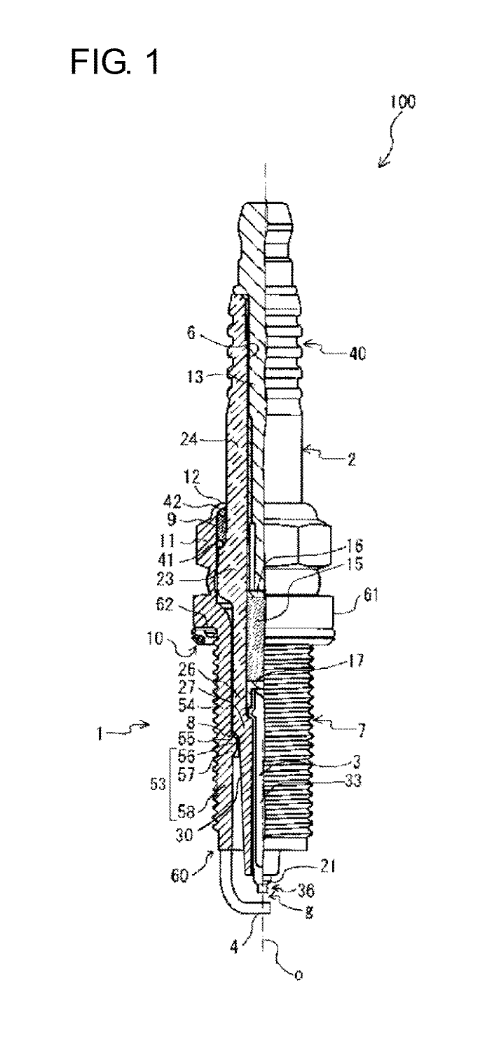

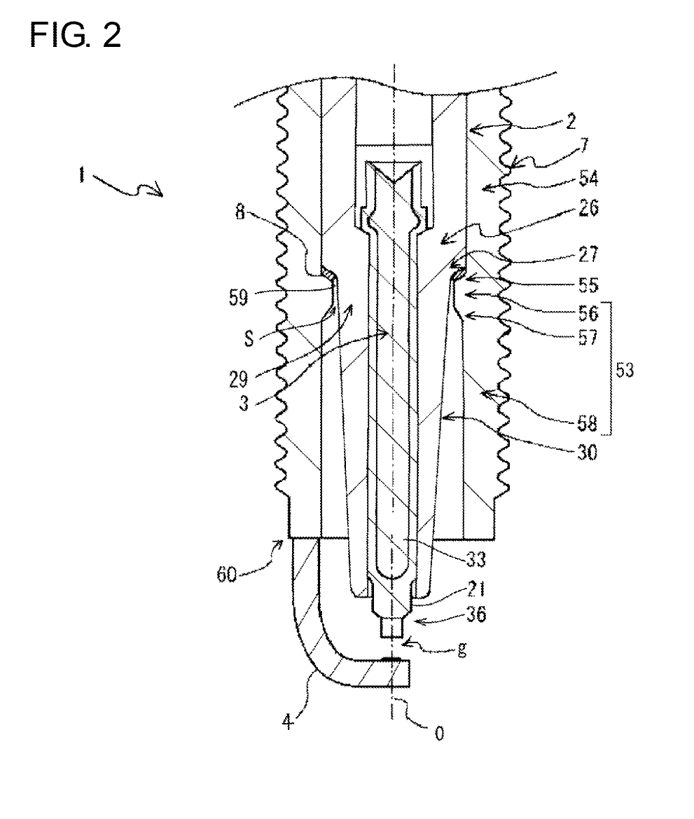

The spark plug that is one example of the spark plug according to this invention is described by referring to FIGS. 1 and 2. The spark plug 100 is used as an ignition plug for an internal combustion engine such as automotive engine. In the following description, an axis (the dashed-dotted line in FIGS. 1 and 2) of the spark plug 100 configured in an approximate bar shape is termed as an “axis O”. In FIGS. 1 and 2, the lower side of the drawing, that is, the side on which a ground electrode 4 is provided, is termed as the front end side of the spark plug 100, and the upper side of the drawing, that is, the side on which a corrugation portion 40 is formed, is termed as the rear end side of the spark plug 100.

The basic configuration of the spark plug 100 is described below. As shown in FIG. 1, the spark plug 100 includes an insulator 2 being formed in an approximately cylindrical shape to have a small-diameter nose portion 30 on the front end side and having a through hole 6 penetrating in the axis O direction, a center electrode 3 inserted from the front end side of the through hole 6, a metal shell 1 having, on the inner peripheral surface, an engagement convex portion 56 protruding inside in the diameter direction, and being formed in an approximately cylindrical shape to hold the internally inserted insulator 2 by the engagement convex portion 56, and a ground electrode 4 with one end portion being connected to the metal shell 1 and the other end portion facing the center electrode 3 to form a spark discharge gap g between the other end portion and the center electrode 3.

More specifically, as shown in FIG. 1, the spark plug 100 includes an approximately cylindrical metal shell 1 having, on the inner peripheral surface, an engagement convex portion 56 protruding in a ring manner toward the inside in the diameter direction, an approximately cylindrical insulator (in this invention, sometimes referred to as an “insulating insulator”) 2 internally inserted into the metal shell 1 and held by the engagement convex portion 56 to protrude from the front end portion in the axis O direction of the metal shell 1, an approximately bar-shaped center electrode 3 internally inserted into the through hole 6 of the insulator 2 to let the electrode front end portion 36 protrude from the front end of the insulator 2, and a ground electrode 4 arranged such that one end is welded to the front end portion in the axis O direction of the metal shell 1 and the other end side opposite to the one end side is laterally bent to let the side surface thereof face the electrode front end portion 36 of the center electrode 3.

In the spark plug 100, as shown in FIGS. 1 and 2, the insulator 2, specifically, the neighborhood of the front end portion of the later-described nose portion 30, protrudes to the ground electrode 4 side relative to the front end surface of the metal shell 1, and the electrode front end portion 36 of the center electrode 3 protrudes to the ground electrode 4 side relative to the front end surface of the insulator 2. A basal portion gap S sandwiched and defined between the inner peripheral surface 59 of the metal shell 1 and the outer peripheral surface of the nose portion 30 is formed between the metal shell 1 and the nose portion 30 of the insulator 2.

As shown in FIG. 1, the metal shell 1 is formed in an approximately cylindrical shape having an engagement convex portion 56 on the inner peripheral surface by using a metal such as low carbon steel and is used as the housing of the spark plug 100. A fixing screw portion 7 for fixing the spark plug to an engine head (not shown) is formed on the outer peripheral surface at the front end portion side in the axis O direction of the metal shell 1. Examples of the standard of the fixing screw portion 7 include M10, M12 and M14. In this invention, the nominal designation of the fixing screw portion 7 means the value specified in ISO2705 (M12), ISO2704 (M10) and the like and of course, variation in the range of dimensional tolerance specified in the standards is allowed. The spark plug according to this invention may be a small spark plug where the nominal diameter of the fixing screw portion 7 is, for example, M12 or less. A tool engagement portion 11 for externally engaging a tool such as spanner and wrench when fixing the metal shell 1 to an engine head is formed on the rear end side in the axis O direction of the fixing screw portion 7 in the metal shell 1. In the spark plug 100, the cross-section orthogonal to the axis O direction of the tool engagement portion 11 forms a hexagonal shape. In the metal shell 1, as shown in FIG. 1, a brim portion 61 provided to protrude outside in the outer diameter direction is formed at an approximately intermediate portion in the axis O direction of the tool engagement portion 11 on the front end side in the axis O direction, and a gasket 10 is inserted into the vicinity of the rear end side in the axis O direction of the fixing screw portion 7, that is, inserted to fit on the seating surface 62 of the brim portion 61.

As shown in FIGS. 1 and 2, the metal shell 1 includes a metal shell rear end portion 54 on the brim portion 61 side that is the front end side in the axis O direction of the brim portion 61, a metal shell front end portion 53 being provided on the front end side of the metal shell 1 and having, at least on the rear end side, a portion where the inner diameter becomes smaller than the inner diameter of the metal shell rear end portion 54, and a first metal shell stepped portion 55 connecting the metal shell rear end portion 54 and the metal shell front end portion 53.

More specifically, as shown in FIGS. 1 and 2, the metal shell 1 includes a metal shell rear end portion 54 formed on the front end side in the axis O direction relative to the tool engagement portion 11 of the metal shell 1, an engagement convex portion 56 (in this invention, sometimes referred to as a “metal shell basal portion”) provided to protrude inside in the inner diameter direction of the metal shell 1 and formed on the front end side in the axis O direction of the metal shell rear end portion 54, a first metal shell stepped portion 55 connecting the metal shell basal portion 56 and the metal shell rear end portion 54, a metal shell forward portion 58 having approximately the same inner diameter as the metal shell rear end portion 54, and a second metal shell stepped portion 57 being formed on the front end side in the axis O direction of the metal shell basal portion 56 and connecting the metal shell forward portion 58 and the metal shell basal portion 56. Accordingly, in the metal shell 1, a metal shell rear end portion 54, a first metal shell stepped portion 55, a metal shell basal portion 56, a second principal stepped portion 57 and a metal shell forward portion 58 are continuously formed in this order from the brim portion 61 toward the front end side in the axis O direction. In this invention, the metal shell front end portion 53 includes the metal shell forward portion 58, the second metal shell stepped portion 57 and the metal shell basal portion 56. The first metal shell stepped portion 55 is a metal shell-side engagement part for engaging with a first insulator stepped portion 27 of the later-described insulator 2.

As shown in FIGS. 1 and 2, the engagement convex portion 56 is an annular convex portion having a substantially constant inner diameter in the axis O direction and making a circuit in the circumferential direction of the inner hole of the metal shell 1. The engagement convex portion 56 forms a trapezoidal cross-section together with the first metal shell stepped portion 55 and the second metal shell stepped portion 57. Accordingly, the inner peripheral surface 59 of the engagement convex portion 56 extends along the axis O.

As shown in FIG. 1, the insulator 2 has an approximately cylindrical shape, in which the center electrode 3 is inserted and held. The insulator 2 has a through hole 6 penetrating along the axis O direction. An approximately bar-shaped terminal fitting 13 is inserted from the rear end portion in the axis O direction of the through hole 6, and an approximately bar-shaped center electrode 3 is inserted from the other end side opposite to the one end side of the through hole 6, where the terminal fitting 13 is inserted, that is, the front end side of the through hole 6. A resistive element 15 is provided between the terminal fitting 13 and the center electrode 3 inserted into the through hole 6, as shown in FIG. 1. Electrically conductive glass seal layers 16 and 17 are provided, respectively, at both end portions in the axis O direction, that is, the front end portion and the rear end portion, of the resistive element 15. The center electrode 3 and the terminal fitting 13 are electrically connected to each other through the electrically conductive glass seal layers 16 and 17. In this way, the resistive element 15 and the electrically conductive glass seal layers 16 and 17 constitute a sintered electrically conductive material portion. The resistive element 15 is formed of a resistive element composition using, as the raw material, a mixed powder of a glass powder, an electrically conductive material powder and, if desired, a ceramic powder other than glass. A high-voltage cable (not shown in FIG. 1) is connected through a plug cap (not shown in FIG. 1) to let a high voltage be applied at the rear end portion in the axis O direction of the terminal fitting 13.

In the insulator 2, as shown in FIG. 1, a protrusion portion 23 protruding outside in the outer diameter direction from the outer peripheral surface of the insulator 2 is formed like a flange at an approximately intermediate portion in the axis O direction of the insulator 2. In the insulator 2, as shown in FIG. 1, a corrugation portion 40 where the stepped surface including the axis line of the insulator 2 has a corrugated shape is formed on the outer peripheral surface at the rear end side in the axis O direction relative to the protrusion portion 23. The corrugation portion 40 imparts a corrugated shape to the outer peripheral surface of the insulator 2 and widens the surface area of the outer peripheral surface of the insulator 2. Accordingly, for example, even when an electricity leaking down the outer peripheral surface of the insulator 2 flows to cause electric leakage (leak phenomenon), the electricity is exhausted in the course of flowing down the outer peripheral surface of the insulator 2, and an effect of preventing electric leakage is obtained.

The insulator 2 includes an insulator rear end portion 26 being located on the front end side in the axis O direction relative to the protrusion portion 23 and extending to the front end side from the protrusion portion 23, a nose portion 30 being provided on the front end side of the insulator rear end portion and having a diameter smaller than the outer diameter of the insulator rear end portion 26 (in this invention, sometimes referred to as an “insulator front end part”), and a first insulator stepped portion 27 connecting the insulator rear end portion 26 and the nose portion 30.

More specifically, as shown in FIGS. 1 and 2, the insulator 2 includes, in the axis O direction of the insulator 2, an insulator rearward portion 24 formed on the rear end side in the axis O direction relative to the protrusion portion 23, an insulator rear end portion 26 formed on the forward side relative to the protrusion portion 23, a nose portion 30 formed on the front end side in the axis O direction of the insulator rear end portion 26, and a first insulator stepped portion 27 connecting the nose portion 30 and the insulator rear end portion 26 and forming a circumferential stepped portion. The nose portion 30 has a smaller diameter than the outer diameter of the insulator rear end portion 26 and is reduced in the diameter such that the outer diameter becomes small gradually toward the front end side in the axis O direction. That is, as shown in FIGS. 1 and 2, the nose portion 30 forms an approximately circular truncated cone. The basal portion gap S provided between the inner peripheral surface 59 and the outer peripheral surface of the nose portion 30 is formed on the front end side in the axis O direction relative to the later-described plate packing 8 disposed between the first insulator stepped portion 27 and the first metal shell stepped portion 55.

In the spark plug 100, the insulator 2 is inserted from the opening on the rear end side in the axis O direction of the metal shell 1 and, as shown in FIG. 1, the first insulator stepped portion 27 of the insulator 2 is engaged with or caught by the first metal shell stepped portion 55 of the metal shell 1. The first insulator stepped portion 27 serves as the insulator-side engagement portion for engaging with the first metal shell stepped portion 55. Between the first metal shell stepped portion 55 of the metal shell 1 and the first insulator stepped portion 27, as shown in FIGS. 1 and 2, an approximately ring-shaped plate packing 8 is provided. In this way, the first insulator steeped portion 27 and the first metal shell stepped portion 55 are engaged through the plate packing 8, whereby the insulator 2 is prevented from slipping off in the axis O direction. The plate packing 8 is formed of a material having high thermal conductivity, such as copper. When the thermal conductivity of the plate packing 8 is high, the spark plug 100 enjoys good heat drainage and is enhanced in the heat resistance. This material is preferably a material having a thermal conductivity of 200 W/m·K or more, such as copper and aluminum. Above all, when the nominal diameter of the fixing screw portion 7 in the spark plug 100 is as small as M12 or less, a particularly high heat resistance effect is exerted.

In the spark plug 100, an approximately ring-shaped plate packing 41 engaging with the peripheral edge on the rearward side of the protrusion portion 23 is disposed between the opening inner surface on the rear end side in the axis O direction of the metal shell 1 and the outer peripheral surface of the insulator 2, and an approximately ring-shaped packing 42 is disposed on the rearward side thereof through a packed layer 9 such as talc. The insulator 2 is pushed toward the front end side in the axis O direction of the metal shell 1. In this state, the opening peripheral edge portion of the metal shell 1 is swaged to the packing 42, whereby a swage portion 12 is formed and the metal shell 1 is held on the insulator 2.

The center electrode 3 is fixed to the axial hole of the insulator 2 in the state of the front end portion of the electrode protruding from the front end surface of the insulator 2 and thereby insulated from and held in the metal shell 1. The center electrode 3 has, at least in the surface layer portion, an electrode base member 21 made of, for example, an Ni (nickel)-based alloy such as Inconel (trademark) 600 or 601, and a core member 33 using Cu (copper), a Cu alloy or the like as the main component is embedded inside the base member for accelerating heat dissipation. That is, the center electrode 3 includes an outer member working out to the main body and a core member 33 formed to be embedded concentrically in the axial core portion inside the outer member. The spark plug 100 including a center electrode 3 where the core member 33 is deeply embedded inside in this way is resistant to “burn” and is suitably used as a wide-range plug usable in a wide range of temperatures.

As shown in FIG. 1, the ground electrode 4 is formed of a metal having high corrosion resistance and, for example, a Ni alloy such as Inconel (trademark) 600 or 601 is used for the ground electrode. The ground electrode 4 whose transverse cross-section orthogonal to the longitudinal direction of the electrode itself is approximately rectangular has a bent, square bar-like outer shape. As shown in FIG. 1, one end portion of the square bar is connected to a connection portion 60 in one end portion on the front end side in the axis O direction of the metal shell 1 by welding or the like. The other end portion (also referred to as the front end part) opposite to the one end portion of the ground electrode 4 is laterally folded back to face the electrode front end portion 36 of the center electrode 3 in the axis O direction of the center electrode 3 and, as shown in FIGS. 1 and 2, a spark discharge gap g is formed in the gap between opposing surfaces of the electrode front end portion 36 of the center electrode 3 and the ground electrode 4. The spark discharge gap g is usually set to be from 0.3 to 1.5 mm.

In this invention, the insulator 2 of the spark plug 100 is formed by an alumina-based sintered body containing an Al component as the main component. This alumina-based sintered body is formed by an alumina-based sintered body containing a Ba component, containing a Si component, a Ca component and an Mg component to satisfy the following conditions (1) and (2), and containing substantially no B component. When the insulator 2 or the like is formed by such an alumina-based sintered body, the spark plug 100 can exert high acid resistance and high-temperature withstand voltage characteristics. Condition (1): the ratio R_{Ca} of the mass (in terms of oxide) of the Ca component to the mass (in terms of oxide) of the Si component is from 0.05 to 0.40; and Condition (2): the ratio R_{Mg} of the mass (in terms of oxide) of the Mg component to the total mass of the mass (in terms of oxide) of the Si component, the mass (in terms of oxide) of the Ca component and the mass (in terms of oxide) of the Mg component is from 0.01 to 0.08.

The Al component is usually alumina (Al₂O₃) and is present as the main component in the alumina-based sintered body. In this invention, the “main component” indicates a component having a highest content. When the Al component is contained as the main component, the sintered body is excellent in the withstand voltage characteristics (hereinafter, includes high-temperature withstand voltage characteristics), heat resistance and mechanical properties. The content of the Al component in the alumina-based sintered body is preferably from 89.0 to 97.0 mass %, more preferably from 90.0 to 93.8 mass %, assuming that the entire mass (in terms of oxide) of the alumina-based sintered body is 100 mass %. When the content of the Al component is in the range above, the alumina-based sintered body itself is dense, for example, the later-described area ratio (S₄/S) of 1.0% or less, and at the same time both the acid resistance and the withstand voltage characteristics, particularly, high-temperature withstand voltage characteristics, can be satisfied. For example, if the Al component is less than 89.0 mass %, the ratio of the glass phase occupying in the grain boundary of the alumina-based sintered body is increased and the high-temperature withstand voltage characteristics may be impaired. On the other hand, if the Al component exceeds 97.0 mass %, the alumina-based sintered body itself may be dense but the amount of liquid phase is decreased and the alumina-based sintered body may be corroded by acid at a high rate, leading to deterioration of the acid resistance. In this invention, the content ratio of the Al component is mass % in terms of oxide when converted into “alumina (Al₂O₃)” which is an oxide of the Al component.

The Si component is a component derived from the sintering aid and is present as an oxide, an ion or the like in the alumina-based sintered body. The Si component usually melts at the sintering to form a liquid phase and therefore, functions as a sintering aid to accelerate the densification of the sintered body. After sintering, the Si component often forms a low melting point glass or the like in the grain boundary of alumina crystal particles. However, when the alumina-based sintered body contains other specific components described later in addition to the Si component, a high melting point glass phase or the like is liable to be preferentially formed together with other components, rather than a low melting point glass phase. As a result, the alumina-based sintered body hardly melts at a low temperature and therefore, migration or the like which may give rise to insulation breakdown is scarcely caused. The content of the Si component is preferably from 1.0 to 8.0 mass %, assuming that the entire mass (in terms of oxide) of the alumina-based sintered body is 100 mass %. In this invention, the content ratio and mass of the Si component are mass % in terms of oxide and mass in terms of oxide when converted into “SiO₂” which is an oxide of the Si component, respectively.

The Ca component is contained in the alumina-based sintered body as a kind of a Group 2 element in the periodic table based on the recommendation of IUPAC 1990 (hereinafter, sometimes referred to as a Group 2 element component). The Ca component is a component derived from the sintering aid and present as an oxide, an ion or the like in the alumina-based sintered body and not only functions as a sintering aid but also functions to enhance the high-temperature strength of the alumina-based sintered body obtained. Accordingly, when the alumina-based sintered body contains the Ca component, a dense alumina-based sintered body results and the withstand voltage characteristics and high-temperature strength are enhanced. The Ca components forms a glass phase, for example, a SiO₂—CaO glass phase, together with the Si component in the grain boundary of alumina crystal particles. The inventors of this invention have found that the mass of the Ca component with respect to the Si component in the glass phase is particularly important for acid resistance of the alumina-based sintered body. In this invention, the Ca component is present in the alumina-based sintered body in a content ratio satisfying the condition (1). That is, the ratio (hereinafter, sometimes referred to as mass ratio) R_{Ca} of the mass (in terms of oxide) of the Ca component to the mass (in terms of oxide) of the Si component in the alumina-based sintered body is from 0.05 to 0.40. If the mass ratio R_{Ca} of the Ca component in the alumina-based sintered body is less than 0.05, the alumina-based sintered body suffers from low sinterability and is not dense, as a result, the alumina-based sintered body cannot exert sufficient acid resistance. On the other hand, if the mass ratio R_{Ca} of the Ca component in the alumina-based sintered body exceeds 0.40, the sinterability of the alumina-based sintered body may be improved, but the glass phase itself becomes readily corroded by acid and therefore, the alumina-based sintered body cannot exert sufficient acid resistance. As for the reason why the glass phase itself becomes readily corroded by acid, the inventors of this invention presume that Ca is bonded by an ion bond in the glass phase and is not stable to acid as compared with Si and a glass phase having a larger Ca component content is more unstable to acid. That is, when the mass ratio R_{Ca} of the Ca component in the alumina-based sintered body is in the range above, the alumina-based sintered body is dense and the glass phase is hardly corroded by acid, leading to high acid resistance of the alumina-based sintered body. As a result, the spark plug 100 including an insulator 2 formed by this alumina-based sintered body exerts high acid resistance. In this invention, from the standpoint that both the sinterability of the alumina-based sintered body and the acid corrosion resistance of the glass phase can be satisfied in a higher level and the alumina-based sintered body exerts higher acid resistance, the mass ratio R_{Ca} is preferably from 0.1 to 0.2. For example, assuming that the total mass (in terms of oxide) of the alumina-based sintered body is 100 mass %, the content ratio of the Ca component in the alumina-based sintered body is appropriately selected from the range of 0.2 to 2.5 mass % so that the mass ratio R_{Ca} can fall in the range above. In this invention, the mass and content ratio of the Ca component are mass in terms of oxide and mass % in terms of oxide when converted into “CaO” which is an oxide of the component, respectively.

The Ba component is contained in the alumina-based sintered body as a kind of a Group 2 element component. The Ba component is a component derived from the sintering aid, similarly to the Ca component, and present as an oxide, an ion or the like in the alumina-based sintered body and not only functions as a sintering aid but also functions to enhance the high-temperature strength of the alumina-based sintered body obtained. When the alumina-based sintered body contains the Ba component, a portion of the Ca component and the like is replaced by the Ba component and migration at a high temperature or at the application of a high voltage hardly occurs, as a result, the withstand voltage characteristics, particularly, high-temperature withstand voltage characteristics, of the alumina-based sintered body is enhanced. Assuming that the total mass (in terms of oxide) of the alumina-based sintered body is 100 mass %, the content of the Ba component in the alumina-based sintered body is appropriately selected from the range of 0.1 to 2.1 mass %. In this invention, the content ratio of the Ba component is mass % in terms of oxide when converted into “BaO” which is an oxide of the component.

The Mg component is contained in the alumina-based sintered body as a kind of a Group 2 element. The Mg component is a component derived from the sintering aid and present as an oxide, an ion or the like in the alumina-based sintered body and functions as a sintering aid, similarly to the Si component before sintering. Accordingly, when the alumina-based sintered body contains the Mg component, the withstand voltage characteristics and high-temperature strength are enhanced and at the same time, the sintering temperature at the firing is decreased. In this invention, the Mg component is present in the alumina-based sintered body in a content ratio satisfying the condition (2). That is, the ratio (hereinafter, sometimes referred to as mass ratio) R_{Mg} of the mass (in terms of oxide) of the Mg component to the total mass of the mass (in terms of oxide) of the Si component, the mass (in terms of oxide) of the Ca component and the mass (in terms of oxide) of the Mg component is from 0.01 to 0.08. If the mass ratio R_{Mg} of the Mg component in the alumina-based sintered body is less than 0.01, the alumina-based sintered body suffers from low sinterability and is not dense, as a result, the alumina-based sintered body cannot exert sufficient acid resistance. On the other hand, if the mass ratio R_{Mg} of the Mg component in the alumina-based sintered body exceeds 0.08, sufficient high-temperature withstand voltage characteristics cannot be exerted. That is, when the mass ratio R_{Mg} of the Mg component in the alumina-based sintered body is in the range above, the alumina-based sintered body is dense and not only the acid resistance is enhanced but also the high-temperature withstand voltage characteristics are improved. As a result, the spark plug 100 including the insulator 2 formed by this alumina-based sintered body exerts high acid resistance and high-temperature withstand voltage characteristics. For example, assuming that the total mass (in terms of oxide) of the alumina-based sintered body is 100 mass %, the content ratio of the Mg component in the alumina-based sintered body is appropriately selected from the range of 0.01 to 0.60 mass % so that the mass ratio R_{Mg} can fall in the range above. In this invention, the mass and content ratio of the Mg component are mass in terms of oxide and mass % in terms of oxide when converted into “MgO” which is an oxide of the component.

The alumina-based sintered body contains substantially no B component. When the alumina-based sintered body does not contain a B component, since a B component relatively weak in the bonding force and prone to corrosion by acid is not present in the glass phase, the glass phase and the alumina-based sintered body are kept from reduction in the acid resistance. The expression “contains substantially no B component” as used in this invention means that the B component is not aggressively incorporated into the alumina-based sintered body by addition or the like, and does not mean that even a B component contained as an unavoidable impurity in other components and the like is not contained.

The alumina-based sintered body contains an Al component, a Si component, a Ba component, a Ca component and an Mg component and contains substantially no B component but may contain a Group 2 element component other than Ca component, Ba component and Mg component, and/or a rare earth element component (sometimes referred to as RE component).

The Group 2 element component is a Group 2 element component in the periodic table and in view of low toxicity, the component other than Ca component, Ba component and Mg component includes a Sr component. The Sr component is a component derived from the sintering aid and present as an oxide, an ion or the like in the alumina-based sintered body and similarly to the Ca component and the Ba component, functions as a sintering aid and also functions to enhance the high-temperature strength of the alumina-based sintered body obtained. Accordingly, when the alumina-based sintered body contains the Sr component, the withstand voltage characteristics and high-temperature strength are enhanced and at the same time, the sintering temperature at the firing is decreased.

In this invention, the Group 2 element component may be at least three components of Ca component, Ba component and Mg component and may be also four components of Mg component, Ba component, Ca component and Sr component. In the case where the alumina-based sintered body contains an Sr component, assuming that the total mass (in terms of oxide) of the alumina-based sintered body is 100 mass %, the content ratio of the Sr component is appropriately selected, for example, from the range of 0.2 to 0.9 mass %. In this invention, the content ratio of Sr is mass % in terms of oxide when converted into “SrO” which is an oxide of the component.

In this invention, the content ratio of the Group 2 element component is sufficient if it satisfies the conditions (1) and (2), and assuming that the total mass (in terms of oxide) of the alumina-based sintered body is 100 mass %, the total content ratio of respective components as the Group 2 element component is preferably from 0.3 to 6.0 mass % from the standpoint that even when a raw material powder having a relatively large particle diameter is used, the alumina-based sintered body becomes dense and works as an insulator excellent in the withstand voltage characteristics and high-temperature strength.

The rare earth element component is a component containing an Sc, Y or lanthanoid element and specifically includes an Sc component, a Y component, a La component, a Ce component, a Pr component, a Nd component, a Pm component, an Sm component, an Eu component, a Gd component, a Tb component, a Dy component, an Ho component, an Er component, a Tm component, a Yb component and an Lu component. The RE component is present as an oxide, an ion or the like in the alumina-based sintering body. When the RE component is contained at the sintering, the particle growth of alumina during sintering can be kept from being excessively generated and at the same time, RE-Si glass (rare earth glass) can be formed in the grain boundary together with the Si component, whereby the melting point of the grain boundary glass phase can be increased and the withstand voltage characteristics and high-temperature strength of the alumina-based sintered body can be improved. In the case where the alumina-based sintered body contains the rare earth element component, assuming that the above-described total mass (in terms of oxide) is 100 mass %, the content ratio of the rare earth element component is, for example, preferably from 0.5 to 4.0 mass %. In this invention, the content ratio of the rare earth element component in the alumina-based sintered body is mass % in terms of oxide when converted into “RE₂O₃” which is an oxide of each component, that is, in the case of a Pr component, when converted into “Pr₆O₁₁”. In the case where the alumina-based sintered body contains plural kinds of rare earth element components, the content of the rare earth element component is the total of contents of respective rare earth element components.

In this invention, the content ratio of each component contained in the alumina-based sintered body can be measured as mass % in terms of oxide by quantitative analysis, fluorescent X-ray analysis or chemical analysis by using, for example, an electron beam microanalyzer (EPMA) or an energy dispersion-type microanalyzer (EPMA/EDS). Incidentally, in this invention, the result calculated by the quantitative analysis, fluorescent X-ray analysis or chemical analysis of the alumina-based sintered body closely agrees with the mixing ratio of the raw material powder used for the production of the alumina-based sintered body.

The alumina-based sintered body is substantially composed of the above-described components. The term “substantially” as used herein means that components other than the above-described components are not aggressively incorporated by addition or the like. Accordingly, the alumina-based sintered body may contain unavoidable impurities in the range not impairing the object of this invention. Examples of the unavoidable impurity include Na, S and N. The content of such an unavoidable impurity is preferably smaller and, for example, assuming that the above-described total mass is 100 mass %, the content is preferably 1 mass % or less. The alumina-based sintered body may further contain other components such as Ti component, Mn component and Ni component in a small amount, in addition to those unavoidable impurities.

In the alumina-based sintered body, the ratio (hereinafter, sometimes referred to as the mass ratio) R_{G} of the mass (in terms of oxide) of the liquid phase to the total mass (in terms of oxide) of the alumina-based sintered body is preferably from 6.2 to 10.0 mass %. When the alumina-based sintered body has a liquid phase whose mass ratio R_{G} is in the range above, the alumina-based sintered body exerts higher acid resistance while maintaining high high-temperature withstand voltage characteristics. Here, the liquid phase is sometimes referred to as a grain boundary phase and usually indicates an amorphous phase composed of respective components excluding the Al component out of the components contained in the alumina-based sintered body. Accordingly, the mass ratio R_{G} of the mass of the liquid phase being from 6.2 to 10.0 mass is, in other words, the mass in terms of oxide of the Al component being from 90.0 to 93.8 mass %, assuming that the total mass (in terms of oxide) of the alumina based sintered body is 100 mass %.

When a region of 250 μm×190 μm on the mirror-polished surface of the alumina-based sintered body is observed at a magnification of 500 times in a plurality of places, for example, in 9 places, the area ratio (S₄/S) of the total area S₄ of air holes having an equivalent-circle diameter of 4 μm or more present in the observed region to the area S of the observed region is preferably from 0 to 1.0%. When the alumina-based sintered body has an area ratio (S₄/S) of 0 to 1.0%, since an air hole having an equivalent-circle diameter of 4 μm or more is almost absent, high density and high withstand voltage characteristics can be maintained and at the same time, the surface area of the alumina-based sintered body is scarcely increased by air holes or an acid is less likely to intrude inside the alumina-based sintered body. Accordingly, the alumina-based sintered body exerts high withstand voltage characteristics, particularly, high-temperature withstand voltage characteristics, and higher acid resistance.

The area ratio (S₄/S) is calculated as follows. First, a surface formed by polishing the alumina-based sintered body or the like into a mirror state, that is, a mirror-polished surface, is prepared. The mirror-polished surface is prepared by processing an arbitrary surface or an arbitrary cut surface of the alumina-based sintered body or the like into a flat surface with use of a diamond grindstone of 45 μm and then mirror-polishing the surface with sequential use of diamond pastes of 9 μm, 3 μm and 0.25 μm until the surface roughness Ra becomes about 0.01 μm. The thus-prepared mirror-polished surface is subjected to carbon deposition so as to impart electrical conductivity, and the region of 250 μm×190 μm on the mirror-polished surface is observed at a magnification of 500 times in a plurality of places, for example, in 9 places, by using an electron microscope, and each observed region is photographed. Each SEM reflection electron image photograph taken is binarized by image analysis software (Soft Imaging System “Five”, manufactured by Olympus) to distinguish the void portion corresponding to the air hole. In each SEM reflection electron image photograph, the total area S₄ of void parts where the diameter converted into an equivalent-circle diameter exceeds 4 μm is determined, and the total area S₄ is divided by the area S of the observed region to obtain the area ratio. The thus-obtained area ratio is arithmetically averaged to calculate the area ratio (S₄/S) of the alumina-based sintered body or the like.

The above-described alumina-based sintered body exerts high acid resistance. For example, the alumina-based sintered body exerts acid resistance such that the rate (%) of change in the mass of Ca component and Si component between before and after exposure in an acidic atmosphere is small, specifically, the rate (%) of change in the mass of Ca component and Si component between before and after dipping in concentrated hydrochloric acid for 10 minutes at ordinary temperature is −36% or less, preferably −30% or less, more preferably −20% or less. That is, the rate (%) of change in the mass is the rate (%) of change in the mass of Ca component and Si component between before and after dipping in concentrated hydrochloric acid for 10 minutes at ordinary temperature and therefore, a small rate (%) of change in the mass indicates sufficient resistance to acid which is the concentrated hydrochloric acid. When the rate (%) of change in the mass between before and after dipping in concentrated hydrochloric acid for 10 minutes at ordinary temperature is −36% or less, the spark plug 100 having an insulator 2 formed by this alumina-based sintered body exhibits sufficient acid resistance even when mounted on an internal combustion engine using a biofuel or a mixed fuel as the fuel and exerts desired functions including high-temperature withstand voltage characteristics over a long period of time even when exposed to an acid atmosphere. The rate (%) of change in the mass is the rate (%) of change in the total mass of Ca component and Si component in the alumina-based sintered body between before and after dipping in concentrated hydrochloric acid for 10 minutes at ordinary temperature and, specifically is represented by the formula: [(W2−W1)/W1]×100(%), wherein W1 is the total mass of Ca component and Si component in the alumina-based sintered body before dipping in concentrated hydrochloric acid at ordinary temperature and W2 is the total mass of Ca component and Si component in the alumina-based sintered body after dipping in concentrated hydrochloric acid at ordinary temperature. As for the total mass W1 and the total mass W2, the mass (in ten is of oxide) of each of Ca component and Si component can be calculated fundamentally in the same manner as in the method for measuring the content ratio of each component by using an electron beam microanalyzer (EPMA) or the like.

The alumina-based sintered body above exerts high acid resistance. For example, the alumina-based sintered body exerts acid resistance such that the rate (%) of change in the strength between before and after exposure in an acidic atmosphere is small, specifically, the rate (%) of change in the strength between before and after dipping in concentrated hydrochloric acid for 10 minutes at ordinary temperature is −18% or less, preferably −15% or less, more preferably −10% or less. That is, the rate (%) of change in the strength is the rate (%) of change in the strength between before and after dipping in concentrated hydrochloric acid for 10 minutes at ordinary temperature and therefore, a small rate (%) of change in the strength indicates sufficient resistance to acid which is the concentrated hydrochloric acid. When the rate (%) of change in the strength between before and after dipping in concentrated hydrochloric acid for 10 minutes at ordinary temperature is −18% or less, the spark plug 100 having an insulator 2 formed by this alumina-based sintered body exhibits sufficient acid resistance even when mounted on an internal combustion engine using a biofuel or a mixed fuel as the fuel and exerts desired functions including high-temperature withstand voltage characteristics over a long period of time even when exposed to an acid atmosphere. The rate (%) of change in the strength is the rate (%) of change in the three-point bending strength of the alumina-based sintered body between before and after dipping in concentrated hydrochloric acid for 10 minutes at ordinary temperature and, specifically is represented by the formula: [(S2−S1)/S1]×100(%), wherein S1 is the three-point bending strength of the alumina-based sintered body before dipping in concentrated hydrochloric acid at ordinary temperature and S2 is the three-point bending strength of the alumina-based sintered body after dipping in concentrated hydrochloric acid at ordinary temperature. Here, the three-point bending strength is the strength obtained by producing a specimen of 48 mm×4 mm×3 mm fundamentally in the same manner as the alumina-based sintered body and measuring it under the condition of a spun of 30 mm in accordance with the measurement method specified in JIS R1604.

For example, the rate (%) of change in the mass and the rate (%) of change in the strength tend to become small when the mass ratio R_{Ca} is small, tend to become small when the content rate (%) of the Al component is small, and tend to become small when the surface area, that is, the area ratio (S₄/S), of the alumina-based sintered body is small.

In the spark plug 100, since the insulator 2 is formed by the alumina-based sintered body, the insulator 2 and the alumina-based sintered body have the same composition and the same characteristics. Therefore, according to this invention, a spark plug excellent in the acid resistance and the high-temperature withstand voltage characteristics can be provided. Furthermore, according to this invention, a spark plug ensuring a small change in the strength and excellent high-temperature withstand voltage and exerting high durability in an acid atmosphere even when mounted on a high-power internal combustion engine where an acid atmosphere is formed in the combustion chamber, can be provided.

The production method of the spark plug according to this invention includes a step of producing an insulator by pressure-forming and then sintering a raw material powder containing an Al compound powder as the main component, an Si compound powder, a Ba compound powder, a Ca compound powder and an Mg compound powder to satisfy the following conditions (3) to (5) and not containing a B compound powder. The production method of the spark plug according to this invention is specifically described below. Condition (3): the ratio R_{Ca} of the mass (in terms of oxide) to the mass (in terms of oxide) of the Si compound powder is from 0.05 to 0.40; Condition (4): the ratio R_{Mg} of the mass (in terms of oxide) of the Mg compound powder to the total mass of the mass (in terms of oxide) of the Si compound powder, the mass (in terms of oxide) of the Ca compound powder and the mass (in terms of oxide) of the Mg compound powder is from 0.01 to 0.08; and Condition (5): the total mass of the mass (in terms of oxide) of the Al compound powder, the mass (in terms of oxide) of the Si component powder, the mass (in terms of oxide) of the Ba compound powder, the mass (in terms of oxide) of the Ca compound powder and the mass (in terms of oxide) of the Mg compound powder is 100 mass %.

In the production method of the spark plug according to this invention, depending on the case, the raw material powder may contain respective powders of the same substance as the Al component, the same substance as the Si component, the same substance as the Ba component, the same substance as the Ca component, and the same substance as the Mg component. The raw material powder may be sufficient if it contains an Al compound powder, an Si compound powder, a Ba compound powder, a Ca compound powder and an Mg compound powder, and may additionally contain, for example, a compound powder of a Group 2 element in the periodic table based on the recommendation of IUPAC 1990 (hereinafter, sometimes referred to as a Group 2 element compound powder), other than a Ba compound powder, a Ca compound powder and an Mg compound powder, and/or a rare earth compound powder.

In the production method of the spark plug according to this invention, first, the raw material powder is mixed in a slurry. Here, the mixing ratio of respective powders may be set to the same as the content ratios of respective components above. This mixing is preferably performed over 8 hours or more so that the mixed state of the raw material powder can be made uniform and the obtained sintered body can be highly densified.

The Al compound powder is not particularly limited as long as the compound can be converted to an Al component by firing, and usually, an alumina (Al₂O₃) powder is used. The Al compound powder in practice sometimes contains avoidable impurities such as Na and therefore, a compound powder having high purity is preferably used. For example, the purity of the Al compound powder is preferably 99.5% or more. As the Al compound powder, for obtaining a dense alumina-based sintered body, usually, a powder having an average particle diameter of 0.1 to 5.0 μm is preferably used. Here, the average particle diameter is a value measured by laser diffraction method (Microtrac particle size distribution analyzer (MT-3000) manufactured by Nikkiso Co., Ltd.).

The Si compound powder is not particularly limited as long as the compound can be converted to an Si component by firing, and examples thereof include various inorganic powders such as oxide (including composite oxide), hydroxide, carbonate, chloride, sulfate, nitrate and phosphate of Si. Specific examples thereof include an SiO₂ powder. In the case where a powder other than oxide is used as the Si compound powder, the amount used thereof is figured out by mass % in terms of oxide when converted into an oxide. The purity of the Si compound powder is fundamentally the same as that of the Al compound powder. The average particle diameter D50 of the Si compound powder is preferably from 0.5 to 3.0 μm. When the Si compound powder has an average particle diameter D50 in the range above, the pulverization time of the Si compound powder can be relatively short to realize excellent productivity and moreover, generation of an air hole particularly having an equivalent-circle diameter of 4 μm or more can be prevented. Specifically, when the average particle diameter D50 is increased, an air hole having an equivalent-circle diameter of 4 μm or more is readily generated and the area ratio (S₄/S) tends to become large. The average particle diameter D50 indicates the particle size corresponding to a 50% cumulative value in the particle size distribution and is a value measured by the laser diffraction method using a Microtrac particle size distribution analyzer (MT-3000) manufactured by Nikkiso Co., Ltd.

The Ba compound powder is not particularly limited as long as the compound can be converted to a Ba component by firing, and examples thereof include various inorganic powders such as oxide (including composite oxide), hydroxide, carbonate, chloride, sulfate, nitrate and phosphate of Ba. Specific examples of the Ba compound powder include a BaO powder and a BaCO₃ powder. In the case where a powder other than oxide is used as the Ba compound powder, the amount used thereof is figured out by mass % in terms of oxide when converted into an oxide. The purity of the Ba compound powder is fundamentally the same as that of the Al compound powder. For the same reason as the Si compound powder, the average particle diameter D50 of the Ba compound powder is preferably from 0.5 to 3.0 μm.

The Ca compound powder is not particularly limited as long as the compound can be converted to a Ca component by firing, and examples thereof include various inorganic powders such as oxide (including composite oxide), hydroxide, carbonate, chloride, sulfate, nitrate and phosphate of Ca. Specific examples of the Ca compound powder include a CaO powder and a CaCO₃ powder. In the case where a powder other than oxide is used as the Ca compound powder, the amount used thereof is figured out by mass % in terms of oxide when converted into an oxide. The purity of the Ca compound powder is fundamentally the same as that of the Al compound powder. For the same reason as the Si compound powder, the average particle diameter D50 of the Ca compound powder is preferably from 0.5 to 3.0 μm.

The Mg compound powder is not particularly limited as long as the compound can be converted to an Mg component by firing, and examples thereof include various inorganic powders such as oxide (including composite oxide), hydroxide, carbonate, chloride, sulfate, nitrate and phosphate of Mg. Specific examples of the Mg compound powder include an MgO powder and an MgCO₃ powder. In the case where a powder other than oxide is used as the Mg compound powder, the amount used thereof is figured out by mass % in terms of oxide when converted into an oxide. The purity of the Mg compound powder is fundamentally the same as that of the Al compound powder. For the same reason as the Si compound powder, the average particle diameter D50 of the Mg compound powder is preferably from 0.5 to 3.0 μm.

The Group 2 element compound powder that is optionally added is a powder other than the above-described Ba compound powder, Ca compound powder and Mg compound powder and is not particularly limited as long as the compound can be converted to a Group 2 component other than Ba component, Ca component and Mg component by firing, and examples thereof include various inorganic powders such as oxide (including composite oxide), hydroxide, carbonate, chloride, sulfate, nitrate and phosphate of a Group 2 element other than Ba, Ca and Mg. The Group 2 element compound powder is preferably an Sr compound powder. Specific examples of the Sr compound powder include an SrO powder and an SrCO₃ powder. In the case where a powder other than oxide is used as the Group 2 element compound powder, the amount used thereof is figured out by mass % in terms of oxide when converted into an oxide. The purity of the Group 2 element compound powder is fundamentally the same as that of the Al compound powder. For the same reason as the Si compound powder, the average particle diameter D50 of the Group 2 element compound powder is preferably from 0.5 to 3.0 μm.

The rare earth element compound powder that is optionally added is not particularly limited as long as the compound can be converted to an RE component by firing, and examples thereof include powders such as oxide and composite oxide of a rare earth element. In the case where a powder other than oxide is used as the rare earth element compound powder, the amount used thereof is figured out by mass % in terms of oxide when converted into an oxide. The purity and average particle diameter of the rare earth element compound powder are fundamentally the same as those of the Al compound powder.

In the raw material powder, the content ratio in terms of oxide of each of Al compound powder, Si compound powder, Ba compound powder, Ca compound powder, Mg compound powder and the like is fundamentally the same as each content ratio in the above-described alumina-based sintered body.

Incidentally, for example, a hydrophilic binder may be blended as the binder in the raw material powder. Examples of the hydrophilic binder include polyvinyl alcohol, water-soluble acrylic resin, gum arabic and dextrin. As the solvent in which the raw material powder is dispersed, for example, water or an alcohol may be used. For each of the hydrophilic binder and the solvent, one kind may be used alone, or two or more kinds may be used in combination. As for the amounts used of the hydrophilic binder and the solvent, assuming that the raw material powder is 100 parts by mass, the amount of the hydrophilic binder is from 0.1 to 5.0 parts by mass, preferably from 0.5 to 3.0 parts by mass, and the amount of water used as the solvent is from 40 to 120 parts by mass, preferably from 50 to 100 parts by mass.

The thus-obtained slurry may be prepared to have, for example, an average particle diameter of 1.4 to 5.0 μm. Subsequently, the slurry obtained is spray-dried by a spray drying method or the like and thereby granulated to have an average particle diameter of 50 to 200 μm, preferably from 70 to 150 μm. The average particle diameter above is a value measured by the laser diffraction method (Microtrac particle size distribution analyzer (MT-3000) manufactured by Nikkiso Co., Ltd.).

This granulated material is pressure-formed to obtain an unfired shape-formed body preferably having a shape and a dimension of the insulator 2 above. The pressure-forming is performed under a pressure of 50 to 70 MPa. When the pressure is in this range, the area ratio (S₄/S) in the obtained alumina-based sintered body can be adjusted to be from 0 to 1.0%. Specifically, when the applied pressure is low, the area ratio (S₄/S) becomes large, whereas when the applied pressure is high, the area ratio (S₄/S) becomes small. The resulting unfired shape-formed body is ground to trim the shape of the body itself. The unfired shape-formed body above is formed of a granulated material having a relatively large particle diameter and therefore, excellent in the processability and can be easily arranged in a desired shape by the above-described industrially inexpensive method with high productivity.

The unfired shape-formed body that is ground and arranged in a desired shape in this way is fired in an air atmosphere at 1,500 to 1,700° C., preferably at 1,550 to 1,650° C., over 1 to 8 hours, preferably over 3 to 7 hours, whereby an alumina-based sintered body is obtained. When the firing temperature is from 1,500 to 1,700° C., the sintered body is liable to be sufficiently densified and abnormal particle growth of the alumina component is hardly caused, so that the withstand voltage characteristics and mechanical strength of the obtained alumina-based sintered body can be ensured. Also, when the firing time if from 1 to 8 hours, the sintered body is liable to be sufficiently densified and abnormal particle growth of the alumina component is hardly caused, so that the acid resistance, withstand voltage characteristics and mechanical strength of the obtained alumina-based sintered body can be ensured.

When the unfired shape-formed body having the above-described composition is sintered in this way, an alumina-based sintered body containing an Al component as the main component, an Si component, a Ba component, a Ca component and an Mg component is obtained. This alumina-based sintered body has the above-described acid resistance, an area ratio (S₄/S) in the range above, and a mass ratio R_{G} in the range above. Accordingly, this alumina-based sintered body exerts high acid resistance and high withstand voltage characteristics, particularly, high-temperature withstand voltage characteristics, when used as an insulator of a spark plug. For this reason, the alumina-based sintered body is suitably used as a material to form an insulator possessed by a spark plug for an internal combustion engine using a biofuel or a mixed fuel as the fuel, particularly, as a material to form an insulator possessed by a spark plug for a high-powered internal combustion engine using a biofuel or a mixed fuel as the fuel.

This alumina-based sintered body may be again arranged in its shape and the like, if desired, so as to fit in with the shape and dimension of the insulator 2. In this way, an alumina-based sintered body and a spark plug 100 insulator 2 composed of the alumina-based sintered body can be produced.

Subsequently, a center electrode 3 is inserted into the through hole 6 of the insulator 2 obtained. The insulator 2 having inserted therein a center electrode 3 is inserted into the metal shell 1 described above, and the first metal shell stepped portion 55 is engaged with the first insulator stepped portion 27, thereby fixing the insulator 2 to the metal shell 1. Incidentally, the metal shell 1 is adjusted to the above-described shape and dimension. A ground electrode 4 is connected to the vicinity of the end portion of the metal shell 1 before or after fixing the insulator 2, whereby a spark plug 100 can be produced. In the production method of the spark plug according to this invention, the embodiment of the assembly of a center electrode, an insulator and a metal shell includes, for example, the spark plug according to this invention shown as one example in FIGS. 1 and 2.

The spark plug according to this invention is used as an ignition plug of an internal combustion engine or the like for an automobile and is fixed to a given position by screwing the fixing screw portion 7 with a screw hole provided in a head (not shown) partitioning and forming a combustion chamber of an internal combustion engine.

The spark plug according to this invention is not limited to examples described above and various modifications may be made therein in the range where the object of this invention can be achieved. For example, in the spark plug 100 above, the nose portion 30 forms an approximately circular truncated cone, but in this invention, the nose portion may include a nose basal portion in a cylindrical shape having a substantially uniform outer diameter and a nose front end portion in an approximately circular truncated cone shape having a smaller diameter than the nose basal portion and extending through the stepped portion from the nose basal portion.

Also, the spark plug 100 above includes a center electrode 3 and a ground electrode 4, but in this invention, a noble metal chip may be provided in the front end portion of the center electrode and/or on the surface of the ground electrode. The noble metal chip formed in the front end portion of the center electrode and on the surface of the ground electrode usually has a columnar shape and is adjusted to an appropriate dimension and melt-fixed to the front end portion of the center electrode and the surface of the ground electrode by an appropriate welding method such as laser welding or electric resistance welding. A spark discharge gap described above is formed between the surface of the noble metal chip formed in the front end portion of the center electrode and the surface of the noble metal chip formed on the surface of the ground electrode. Examples of the material forming the noble metal chip include noble metals such as Pt, Pt alloy, Ir and Ir alloy.

### Examples

### (Production of Alumina-Based Sintered Body)

A hydrophilic binder is added to a raw material powder containing an alumina powder, an Si compound powder, Ca, Mg and Ba compound powders as the Group 2 element compound powder and, if desired, a B compound powder (Sample No. 19) or an La₂O₃ powder (Sample No. 5) (the kind of each powder mixed is shown in Table 1) to prepare a slurry. Incidentally, the average particle diameter D50 of each of the Si compound powder and the Group 2 element compound powder was in the above-described range.

The slurry obtained was spray-dried by a spray drying method or the like to granulate a powder having an average particle diameter of about 100 μm. This powder was shape-formed by a rubber press under a press pressure of 50 to 70 MPa to obtain an unfired shape-formed body. This unfired shape-formed body was fired in an air atmosphere by setting the firing temperature in a range of 1,500 to 1,700° C. and the firing time to 1 to 8 hours, whereby each alumina-based sintered body having a dimension of 48 mm×4 mm×3 mm of Sample Nos. 1 to 38 was obtained. Incidentally, the firing conditions all were set to the same conditions in the ranges above. In Table 1 (No. 1) and Table 1 (No. 2) (hereinafter, sometimes collectively referred to as Table 1), the sample marked with “*” is Comparative Example.

### (Measurement of Content Ratio of Component)

The composition, that is, the content ratio of each component, of the obtained alumina-based sintered body was measured by quantitative analysis using an energy dispersion-type microanalyzer (EPMA/EDS) and calculated as the mass ratio (%), assuming that the total mass in terms of oxide of respective components detected is 100 mass %. As for the analysis conditions of the energy dispersion-type microanalyzer (EPMA/EDS), a field-emission electron probe microanalyzer (JXA-8500F, manufactured by JEOL Ltd. was used and set to a spot diameter of φ200 and an accelerating voltage of 20 kV, and the arithmetic average value when measured in 10 places was employed. The results are shown as “Composition (mass % in terms of oxide) in Table 1. Also, each of the mass ratio R_{Ca} and the mass ratio R_{Mg} was calculated from the content ratios of respective components, and the results are shown in Table 1. Furthermore, the total content ratio of content ratios of Si component, Ca component, Mg component, Ba component, La₂O₃ component and B component (Sample No. 19) was calculated, and the results are shown as “Mass Ratio R_{g}” in Table 1. The content ratio of each component shown in Table 1 closely agrees with the mixing ratio in the raw material powder. In addition, the area ratio (S₄/S) of the obtained alumina-based sintered body was measured or calculated by the above-described method, and the results are shown in Table 1.

### (Measurement of Ratio (%) of Change in Mass)

The mass in terms of oxide of each of Ca component an Si component in the alumina-based sintered body was calculated and after dipping in concentrated hydrochloric acid for 10 minutes at ordinary temperature, the sintered body was taken out from the concentrated hydrochloric acid. The alumina-based sintered body after dipping was quantitatively determined for components in the same manner as above by using EPMA/EDS, and the mass in terms of oxide of each of Ca component and Si component in the alumina-based sintered body after dipping in concentrated hydrochloric acid at ordinary temperature was calculated. From the total mass (mass in terms of oxide) W2 of Ca component and Si component after dipping in concentrated hydrochloric acid at ordinary temperature and the total mass (mass in teams of oxide) W1 of Ca component and Si component before dipping in concentrated hydrochloric acid at ordinary temperature, the “rate (%) of change in the mass of Ca component and Si component between before and after dipping in concentrated hydrochloric acid for 10 minutes at ordinary temperature” was calculated and shown as “Rate (%) of Change in Mass” in Table 1.

### (Measurement, etc. of Rate (%) of Change in Strength)

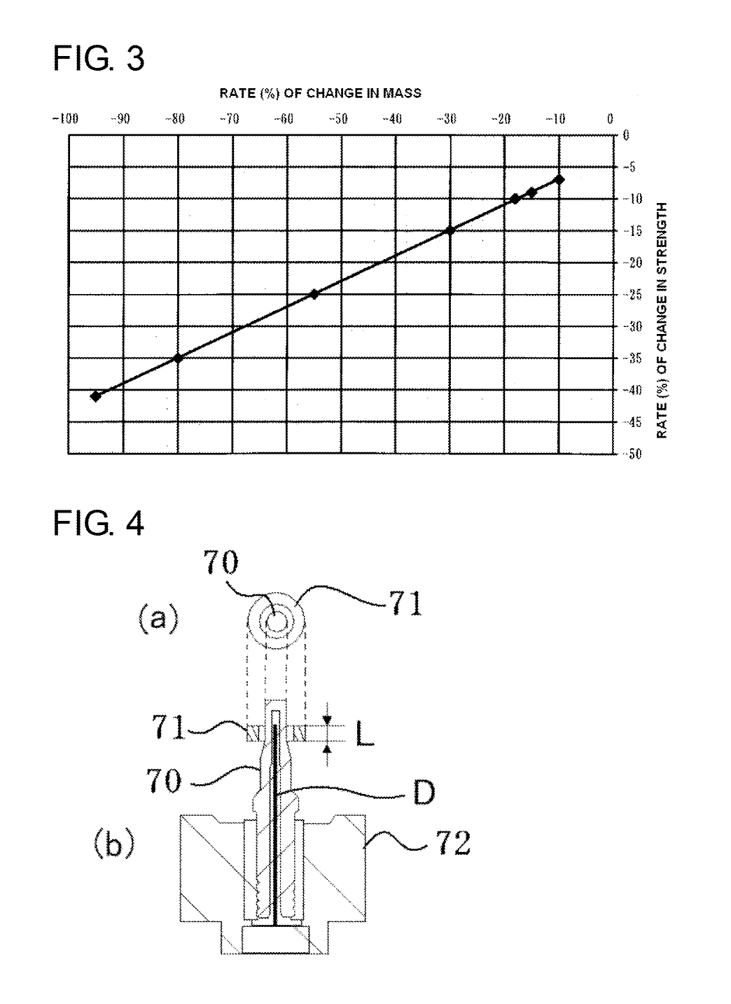

The three-point bending strength S1 in each alumina-based sintered body of Sample Nos. 3, 4, 6 and 10 to 13 was measured in accordance with the above-described method. Subsequently, each alumina-based sintered body of Sample Nos. 3, 4, 6 and 10 to 13 produced in the same manner was dipped in concentrated hydrochloric acid for 10 minutes at ordinary temperature, then taken out from the concentrated hydrochloric acid, and measured for the three-point bending strength S2 in the same manner. With respect to alumina-based sintered bodies having the same sample No., from the three-point bending strength S2 after dipping in concentrated hydrochloric acid at ordinary temperature and the three-point bending strength S1 before dipping in concentrated hydrochloric acid at ordinary temperature, the “rate (%) of change in the strength between before and after dipping in concentrated hydrochloric acid for 10 minutes” was calculated, and FIG. 3 shows the results obtained.

### (Measurement of High-Temperature Withstand Voltage Characteristics)

An insulator 70 shown in FIG. 4(b) for withstand voltage measurement was produced fundamentally in the same manner as in the production of the alumina-based sintered body. The insulator 70 for withstand voltage measurement has an axial hole at the center portion in the axis direction and at the same time, is in a state of the front end portion of the axial hole being closed. Using the insulator 70 for withstand voltage measurement, the withstand voltage at a high temperature was measured. FIG. 4 shows the apparatus for measuring the withstand voltage. FIG. 4(a) is a view overlooking the insulator 70 for withstand voltage measurement and a metal-made ring 71 surrounding the neighborhood of the front end of the insulator 70 for withstand voltage measurement, and FIG. 4(b) is a cross-sectional view of the insulator 70 for withstand voltage measurement and the ring 31. The ring 71 has an axial length L of 3 to 4 mm and is fixed to the vicinity of the front end of the insulator 70 for withstand voltage measurement by means of a fixing device (not shown). One end portion of the insulator 70 for withstand voltage measurement is fixed to the basal portion 72 and the other end portion protrudes from the basal portion 72. A center electrode D is disposed by insertion in the axial hole. In the evaluation of withstand voltage at a high temperature, the insulator 70 for withstand voltage measurement in the portion protruding from the basal portion 72 was high-frequency heated at 600 to 950° C. and by applying a voltage between the center electrode D and the ring 31 in a state where the insulator 70 for withstand voltage measurement in the portion near the easily heatable metal-made ring 31 reached predetermined temperatures of 800° C., 850° C. and 900° C., the voltage value when generating insulation breakdown in the insulator 70 for withstand voltage measurement was measured as the withstand voltage value. The withstand voltage values measured are shown in Table 1.

TABLE 1
(No. 1)

| | Composition | | | | | | | Mass | Mass | Mass | Area | | Withstand Voltage Value | | |
|---|---|---|---|---|---|---|---|---|---|---|---|---|---|---|---|
| Sample | (mass % in terms of oxide) | | | | | | | Ratio | Ratio | Ratio | Ratio | Rate of Change | (kV) | | |
| No. | Al₂O₃ | B₂O₃ | SiO₂ | CaO | MgO | BaO | La₂O₃ | R_{Ca} | B_{Mg} | R_{G} | S₄/S (%) | in Mass (%) | 800° C. | 850° C. | 900° C. |
| *1 | 93.80 | 0.00 | 4.76 | 0.00 | 0.31 | 1.13 | 0.00 | 0.00 | 0.06 | 6.2 | 1.3 | ~38.0 | 29 | 25 | 21 |
| 2 | 93.80 | 0.00 | 4.52 | 0.24 | 0.31 | 1.13 | 0.00 | 0.05 | 0.06 | 6.2 | 1.0 | ~28.0 | 29 | 24 | 22 |
| 3 | 93.80 | 0.00 | 4.31 | 0.45 | 0.31 | 1.13 | 0.00 | 0.10 | 0.06 | 6.2 | 1.0 | ~10.0 | 30 | 25 | 21 |
| 4 | 93.80 | 0.00 | 4.14 | 0.62 | 0.31 | 1.13 | 0.00 | 0.15 | 0.06 | 6.2 | 1.0 | ~15.0 | 29 | 25 | 21 |
| 5 | 93.80 | 0.00 | 3.02 | 0.46 | 0.22 | 0.82 | 1.68 | 0.15 | 0.06 | 6.2 | 1.0 | ~15.0 | 31 | 26 | 22 |
| 6 | 93.80 | 0.00 | 3.96 | 0.80 | 0.31 | 1.13 | 0.00 | 0.20 | 0.06 | 6.2 | 1.0 | ~18.0 | 29 | 24 | 22 |
| 7 | 93.80 | 0.00 | 3.81 | 0.95 | 0.31 | 1.13 | 0.00 | 0.25 | 0.06 | 6.2 | 1.0 | ~20.0 | 30 | 25 | 21 |
| 8 | 93.80 | 0.00 | 3.66 | 1.10 | 0.31 | 1.13 | 0.00 | 0.30 | 0.06 | 6.2 | 1.0 | ~22.5 | 30 | 24 | 21 |
| 9 | 93.80 | 0.00 | 3.52 | 1.24 | 0.31 | 1.13 | 0.00 | 0.35 | 0.06 | 6.2 | 1.0 | ~25.0 | 29 | 24 | 22 |
| 10 | 93.80 | 0.00 | 3.39 | 1.37 | 0.31 | 1.13 | 0.00 | 0.40 | 0.06 | 6.2 | 1.0 | ~30.0 | 30 | 25 | 21 |
| *11 | 93.80 | 0.00 | 3.28 | 1.48 | 0.31 | 1.13 | 0.00 | 0.45 | 0.06 | 6.2 | 1.0 | ~55.0 | 29 | 25 | 21 |
| *12 | 93.80 | 0.00 | 3.18 | 1.58 | 0.31 | 1.13 | 0.00 | 0.50 | 0.06 | 6.2 | 1.0 | ~80.0 | 30 | 24 | 21 |
| *13 | 93.80 | 0.00 | 3.06 | 1.70 | 0.31 | 1.13 | 0.00 | 0.55 | 0.06 | 6.2 | 1.0 | ~95.0 | 30 | 25 | 22 |
| *14 | 93.80 | 0.00 | 2.98 | 1.78 | 0.31 | 1.13 | 0.00 | 0.60 | 0.06 | 6.2 | 1.0 | ~96.0 | 29 | 24 | 22 |
| *15 | 93.80 | 0.00 | 2.88 | 1.88 | 0.31 | 1.13 | 0.00 | 0.65 | 0.06 | 6.2 | 1.0 | ~97.0 | 30 | 25 | 21 |
| *16 | 93.80 | 0.00 | 2.80 | 1.96 | 0.31 | 1.13 | 0.00 | 0.70 | 0.06 | 6.2 | 1.0 | ~98.0 | 30 | 25 | 21 |
| *17 | 93.80 | 0.00 | 2.72 | 2.04 | 0.31 | 1.13 | 0.00 | 0.75 | 0.06 | 6.2 | 1.0 | ~99.0 | 30 | 24 | 21 |
| *18 | 93.80 | 0.00 | 2.64 | 2.12 | 0.31 | 1.13 | 0.00 | 0.80 | 0.06 | 6.2 | 1.0 | ~100.0 | 29 | 24 | 22 |
| *19 | 93.80 | 0.40 | 3.11 | 1.25 | 0.31 | 1.13 | 0.00 | 0.40 | 0.07 | 6.2 | 1.0 | ~34.5 | 29 | 25 | 21 |
| *20 | 93.80 | 0.00 | 4.18 | 1.65 | 0.37 | 0.00 | 0.00 | 0.40 | 0.06 | 6.2 | 1.0 | ~30.0 | 10 | 5 | 3 |

TABLE 1
(No. 2)

| | Composition | | | | | | | Mass | Mass | Mass | Area | | Withstand Voltage Value | | |
|---|---|---|---|---|---|---|---|---|---|---|---|---|---|---|---|
| Sample | (mass % in terms of oxide) | | | | | | | Ratio | Ratio | Ratio | Ratio | Rate of Change | (kV) | | |
| No. | Al₂O₃ | B₂O₃ | SiO₂ | CaO | MgO | BaO | La₂O₃ | R_{Ca} | B_{Mg} | R_{G} | S₄/S (%) | in Mass (%) | 800° C. | 850° C. | 900° C. |
| *21 | 93.80 | 0.00 | 3.62 | 1.45 | 0.00 | 1.13 | 0.00 | 0.40 | 0.00 | 6.2 | 1.3 | ~59.5 | 31 | 25 | 22 |
| 22 | 93.80 | 0.00 | 3.59 | 1.43 | 0.05 | 1.13 | 0.00 | 0.40 | 0.01 | 6.2 | 1.0 | ~30.0 | 29 | 24 | 22 |
| 23 | 93.80 | 0.00 | 3.51 | 1.41 | 0.15 | 1.13 | 0.00 | 0.40 | 0.03 | 6.2 | 1.0 | ~30.0 | 30 | 24 | 21 |
| 24 | 93.80 | 0.00 | 3.44 | 1.38 | 0.25 | 1.13 | 0.00 | 0.40 | 0.05 | 6.2 | 1.0 | ~30.0 | 30 | 25 | 21 |
| 25 | 93.80 | 0.00 | 3.37 | 1.35 | 0.35 | 1.13 | 0.00 | 0.40 | 0.07 | 6.2 | 1.0 | ~30.0 | 29 | 25 | 22 |
| 26 | 93.80 | 0.00 | 3.34 | 1.33 | 0.40 | 1.13 | 0.00 | 0.40 | 0.08 | 6.2 | 1.0 | ~30.0 | 30 | 24 | 22 |
| *27 | 93.80 | 0.00 | 3.30 | 1.32 | 0.45 | 1.13 | 0.00 | 0.40 | 0.09 | 6.2 | 1.0 | ~30.0 | 11 | 6 | 3 |
| 28 | 88.90 | 0.00 | 7.10 | 1.43 | 0.55 | 2.02 | 0.00 | 0.20 | 0.06 | 11.1 | 1.0 | ~10.5 | 24 | 20 | 16 |
| 29 | 90.00 | 0.00 | 6.39 | 1.29 | 0.49 | 1.82 | 0.00 | 0.20 | 0.06 | 10.0 | 1.0 | ~10.7 | 28 | 24 | 21 |
| 30 | 92.70 | 0.00 | 4.67 | 0.94 | 0.36 | 1.33 | 0.00 | 0.20 | 0.06 | 7.3 | 1.0 | ~12.8 | 29 | 25 | 22 |
| 31 | 93.00 | 0.00 | 4.47 | 0.90 | 0.35 | 1.28 | 0.00 | 0.20 | 0.06 | 7.0 | 1.0 | ~14.2 | 30 | 24 | 21 |
| 32 | 93.30 | 0.00 | 4.28 | 0.86 | 0.33 | 1.22 | 0.00 | 0.20 | 0.06 | 6.7 | 1.0 | ~13.9 | 29 | 24 | 22 |
| 33 | 93.60 | 0.00 | 4.09 | 0.83 | 0.32 | 1.17 | 0.00 | 0.20 | 0.06 | 6.4 | 1.0 | ~16.7 | 30 | 24 | 22 |
| 6 | 93.80 | 0.00 | 3.96 | 0.80 | 0.31 | 1.13 | 0.00 | 0.20 | 0.06 | 6.2 | 1.0 | ~18.0 | 29 | 24 | 22 |
| 34 | 93.90 | 0.00 | 3.90 | 0.79 | 0.30 | 1.11 | 0.00 | 0.20 | 0.06 | 6.1 | 1.0 | ~24.5 | 29 | 24 | 21 |
| 35 | 93.80 | 0.00 | 3.96 | 0.80 | 0.31 | 1.13 | 0.00 | 0.20 | 0.06 | 6.2 | 0.0 | ~9.5 | 31 | 26 | 22 |
| 36 | 93.80 | 0.00 | 3.96 | 0.80 | 0.31 | 1.13 | 0.00 | 0.20 | 0.06 | 6.2 | 0.5 | ~14.5 | 30 | 25 | 22 |
| 37 | 93.80 | 0.00 | 3.96 | 0.80 | 0.31 | 1.13 | 0.00 | 0.20 | 0.06 | 6.2 | 0.9 | ~17.5 | 29 | 24 | 22 |
| 6 | 93.80 | 0.00 | 3.96 | 0.80 | 0.31 | 1.13 | 0.00 | 0.20 | 0.06 | 6.2 | 1.0 | ~18.0 | 29 | 24 | 22 |
| 38 | 93.80 | 0.00 | 3.96 | 0.80 | 0.31 | 1.13 | 0.00 | 0.20 | 0.06 | 6.2 | 1.1 | ~24.0 | 29 | 25 | 22 |

As seen from Table 1, when the alumina-based sintered body contains a Ba compound, contains an Si component, a Ca component and an Mg component to satisfy the conditions (1) and (2) and contains substantially no B component, for example, as seen in Sample Nos. 2 to 10, 22 to 26 and 28 to 38, the rate (%) of change in mass was −30.0% and the withstand voltage value at 800° C., 850° C. and 900° C. was as large as 16 to 31 kV. Incidentally, the same results were obtained even when the alumina-based sintered body contains a rare earth element component in addition to Al component, Si component, Ba component, Ca component and Mg component, as seen in Sample Nos. 5 and 6. In particular, when the mass ratio R_{Ca} of the alumina-based sintered body is from 0.1 to 0.2, for example, as seen in Sample Nos. 3 to 6 and 38 to 38, the rate (%) of change in mass was −24.5% or less while keeping a large withstand voltage value.

Referring to FIG. 3, it may be understood that the rate (%) of change in strength is −15% or less when the rate (%) of change in mass is −30% or less, the rate (%) of change in strength is about −12% or less when the rate (%) of change in mass is −24.5% or less, and the rate (%) of change in strength is −10% or less when the rate (%) of change in mass is −18% or less.

In this way, when each of the mass ratio R_{Ca} and the mass ratio R_{Mg} in the alumina-based sintered body is adjusted to fall in the above-described range, as described above, the acid resistance of the glass phase in the alumina-based sintered body rises and the acid resistance of the alumina-based sintered body itself is increased, as a result, reduction in the strength of the alumina-based sintered body is decreased. The insulator formed by such an alumina-based sintered body exerts high acid resistance and is small in the rate (%) of change in mass and the rate (%) of change in strength.

Accordingly, the alumina-based sintered bodies of Sample Nos. 2 to 10, 22 to 26 and 28 to 38 were excellent in the acid resistance and high-temperature withstand voltage characteristics, particularly, the alumina-based sintered bodies of Sample Nos. 3 to 6 and 28 to 38 had higher acid resistance while maintaining the high-temperature withstand voltage characteristics.

Furthermore, when the mass ratio R_{G} of the mass (in terms of oxide) of the liquid phase volume in the alumina-based sintered body is from 6.2 to 10.0 mass %, as seen in Sample Nos. 6 and 28 to 34, the rate (%) of change in mass was reduced to −10.7% from −18.0% while maintaining a large withstand voltage value, and the alumina-based sintered body where the mass ratio R_{G} is from 6.2 to 10.0 mass % had higher acid resistance while maintaining the high-temperature withstand voltage characteristics.

In addition, when the area ratio (S₄/S) in the alumina-based sintered body is from 0 to 1.0%, as seen in Sample Nos. 6 and 35 to 38, the rate (%) of change in mass was reduced to −9.5% from −18.0% while maintaining a large withstand voltage value, and the alumina-based sintered body where the area ratio (S₄/S) is from 0 to 1.0% had higher acid resistance while maintaining the high-temperature withstand voltage characteristics.

On the other hand, even if the alumina-based sintered body contains Si component, Ba component, Ca component and Mg component, when the mass ratio R_{Ca} is less than 0.05 or is 0.45 or more, as seen in Sample Nos. 1 and 11 to 18, the rate (%) of change in mass became a very large value of −38.0% or −55.0% to −100.00%. Referring to FIG. 3, it may be understood that the rate (%) of change in strength is −25% or more when the rate (%) of change in mass is −55.0% (Sample No. 11) or less. Accordingly, it is revealed that the alumina-based sintered bodies of Sample Nos. 1 and 11 to 18 are lacking in adequate acid resistance.

Even if the alumina-based sintered body contains Si component, Ba component, Ca component and Mg component, when the mass ratio R_{Mg} is less than 0.01, as seen in Sample No. 21, the rate (%) of change in mass became a very large value of −59.5%, and also when the mass ratio R_{Mg} is 0.09, as seen in Sample No. 27, the withstand voltage value was greatly reduced.

Furthermore, it could be understood that the alumina-based sintered body not containing Ca component (Sample No. 1) shows a large rate (%) of change in mass and is poor in the acid resistance; the alumina-based sintered body containing 0.40 mass % of B component (Sample No. 19) shows a large rate (%) of change in mass as compared with the alumina-based sintered body of Sample No. 9 and is poor in the acid resistance; and the alumina-based sintered body not containing Ba component (Sample No. 20) shows a small withstand voltage value at 800° C., 850° C. and 900° C. and is poor in the high-temperature withstand voltage characteristics.

### (Production of Spark Plug 1)

Insulators 2 were produced fundamentally in the same manner as in the production of alumina-based sintered bodies of Sample Nos. 2 to 10, 22 to 26 and 28 to 38, and using these insulators 2, spark plugs were produced as described above. Respective spark plugs produced were excellent in the acid resistance and high-temperature withstand voltage characteristics, similarly to the insulator 2.

### INDUSTRIAL APPLICABILITY

As verified above, according to this invention, a spark plug excellent in the acid resistance and high-temperature withstand voltage characteristics can be provided. Furthermore, according to this invention, a spark plug ensuring a small change in the strength and excellent high-temperature withstand voltage and exerting high durability in an acid atmosphere even when mounted on a high-power internal combustion engine involving formation of an acid atmosphere in the combustion chamber, can be provided. Therefore, the spark plug according to this invention is suitably used as a spark plug for a high-powered internal combustion engine or an internal combustion engine using a biofuel or a mixed fuel as the fuel, in particular, suitably used as a spark plug for a high-powered internal combustion engine using a biofuel or a mixed fuel as the fuel.

### DESCRIPTION OF REFERENCE NUMERALS AND SIGNS

100: Spark plug, 1: metal shell, 2: insulator, 3: center electrode, 4: ground electrode, 6: through hole, 7: fixing screw portion, 29: nose basal portion, 30: nose portion (insulator diameter-reduced part), 56: engagement convex portion (metal shell basal part), g: spark discharge gap, and S: basal portion gap

1-4. (canceled)

5. A spark plug comprising:
an insulator being formed in an approximately cylindrical shape and having a through hole penetrating in an axis direction thereof; and
a center electrode inserted into the through hole,
wherein the insulator includes an alumina-based sintered body containing an Si component, a Ba component, a Ca component and an Mg component, and containing substantially no B component, and
wherein following conditions (1) and (2) are satisfied:
condition (1): a ratio R_{Ca} of a mass (in terms of oxide) of the Ca component to a mass (in terms of oxide) of the Si component is from 0.05 to 0.40, and
condition (2): a ratio R_{Mg} of a mass (in terms of oxide) of the Mg component to a total mass of the mass (in terms of oxide) of the Si component, the mass (in terms of oxide) of the Ca component and the mass (in terms of oxide) of the Mg component is from 0.01 to 0.08.

6. The spark plug according to claim 1, wherein the mass ratio R_{Ca} is from 0.1 to 0.2.

7. The spark plug according to claim 1, wherein in the alumina-based sintered body, the mass ratio R_{G} of the mass (in terms of oxide) of a liquid phase volume of the alumina-based sintered body to the total mass of the alumina-based sintered body is from 6.2 to 10.0 mass %.

8. The spark plug according to claim 1, wherein when a region of 250 μm×190 μm on a mirror-polished surface of the alumina-based sintered body is observed at a magnification of 500 times, an area ratio (S₄/S) of a total area S₄ of air holes having an equivalent-circle diameter of 4 μm or more present in the observed region to the area S of the observed region is from 0 to 1.0%.
